(19) United States
(12) Patent Application Publication
(10) Pub. No.: US 2004/0183909 A1
(43) Pub. Date: Sep. 23, 2004

(54) Method of determining the imaging equation for self calibration with regard to performing stereo-PIV methods

(75) Inventor: Bernhard Wieneke, Goettingen (DE)

Correspondence Address: JORDAN AND HAMBURG LLP, 122 EAST 42ND STREET, SUITE 4000, NEW YORK, NY, 10168, US

(73) Assignee: LaVision GmbH, Goettingen (DE)

(21) Appl. No.: 10/725,903

(22) Filed: Dec. 1, 2003

(30) Foreign Application Priority Data
Mar. 21, 2003 (DE) 103 12 696.1-52

(51) Int. Cl. H04N 17/00

(52) U.S. Cl. 348/180

(57) ABSTRACT

The subject matter of the invention is a method for determining the imaging equation for self calibration with regard to performing stereo-PIV methods on visualized flows, said method being comprised of at least two cameras and one image sector, with the cameras viewing approximately the same area of the illuminated section but from different directions, the point correspondences between the two cameras being determined by measuring the displacement of the respective interrogation areas in the camera images using optical cross-correlation, the imaging equation being determined by means of approximation methods, using known internal and external camera parameters.

### 1. FIELD OF THE INVENTION

The invention relates to a method of determining the imaging equation for self calibration with regard to performing stereo-PIV methods.

For a fuller understanding of the invention, the term “PIV method” will first be explained. PIV stands for Particle Image Velocimetry. PIV serves to image the flow conditions of a gas or a fluid in a space (e.g., DE 199 28 698 A1). To carry out such a PIV method, a laser or another suited light source is needed, said light source producing in the flow of a medium such as a gas or a fluid what is called an illuminated section, said illuminated section being viewed by at least one camera. With one camera only being oriented normal to the illuminated section, the two velocity components may be determined in the illumination plane whereas, with at least two cameras (stereo-PIV) viewing the illuminated section from different angles, all of the three components are determined. As already explained, the PIV technique is intended to measure two- and three-dimensional velocity fields; in order to image the velocity of such medium in a space, small particles are added to the fluid or the gas, said particles directly following the flow. This stereo-PIV method first requires calibration, meaning that the position of the camera relative to the plane of the illuminated section is determined, which in the end is obtained by establishing the imaging equation

$$( \begin{matrix}{x}_{1} , {y}_{1} \\ {x}_{2} , {y}_{2}\end{matrix} ) = M ( x , y , z )$$

where xᵢ, yᵢ are the image coordinates of a point in space (x, y, z) in the image of camera 1 and 2 (see FIG. 1). Usually, the coordinate system is established in such a manner that the plane of the illuminated section corresponds to a constant z (e.g., z=0). The pin-hole camera model in which imaging is determined both by external parameters—orientation and position of the cameras relative to each other and to the illuminated section—and by internal camera parameters—i.a., by the spacing between the camera chip and the imaginary pinhole aperture (image width) and by the base point (principal point) of the main optical axis on the camera chip—is often used as the imaging function M. With only few additional distortion parameters it is possible to determine the image at a precision of better than 0.1 pixel. Calibration is performed according to prior art using what is termed a calibration plate that is image captured by the two cameras in one or several positions in the space, with one of said positions having to correspond exactly to the plane of the illuminated section.

Now, the imaging equation can be established either using the calibration plate and knowing the absolute position in space of the two cameras or using the calibration plate, the angle and orientation of the cameras relative to said calibration plate and the spacing between the cameras and the calibration plate, or using a calibration plate that is captured by the cameras in two or more z-positions.

### 2. DESCRIPTION OF THE PRIOR ART

The use of what is termed a three-dimensional calibration plate for establishing the imaging equation is also known, such type three-dimensional calibration plates having e.g., two planes, each plane being provided with a grid pattern having 10×10 fixedly spaced apart marks. These known methods of calibration have various disadvantages. For example, the calibration plate must be positioned at the same site, exactly parallel to the light. This is very difficult to achieve; the smallest deviations from 0.6.degree. already result in a position inaccuracy of 10 pixels on the image border when determining the vector in the two image sectors, with said deviations possibly resulting in a high percentage of errors at strong velocity gradients. Calibration is performed at high expense. If the viewing fields are large, the calibration plates are to be manufactured to size and also possibly be displaced evenly by an exact amount in the Z-direction. Or the angle or the spacing has to be determined, which is also complicated and prone to errors. It is e.g., difficult, when determining the spacing, to determine the distance between the zero point on the calibration plate and an imaginary camera pinhole position. In current objectives with multiple lenses, the latter is located at a certain position within the objective. If calibration or rather the PIV method is carried out in a closed space, e.g., within a tube, it is necessary to provide an access to the tube in order to permit positioning of the calibration plate within said space. Concurrently, it must be made certain that calibration is performed under optical conditions similar to those under which measurement is carried out, meaning calibration is to be performed in a tube with the same fluid and under the same conditions as the subsequent measurement.

With many objects, such as microchannels for example, so-called in situ calibration cannot be realized, or is only to be performed at high expense, since it is very difficult to accommodate the calibration plate therein.

For the same or similar reasons, various methods have been developed in the field of computer viewing and photogrammetry for achieving sufficiently accurate imaging equation without the aid of calibration means. This method, which is termed self calibration, relies on finding in two camera images like points, so-called point correspondences, that belong to the same point in space. If a sufficient number of point correspondences, the individual internal camera parameters in part or in whole and absolute scaling are known, it is possible to determine the above mentioned imaging equation i.e., the remaining internal camera parameters and the orientation and spacing of the cameras relative to each other. However, this method cannot be readily applied to the stereo-PIV technique partly because determining the point correspondences between the cameras is difficult. This is due to the fact that here, the target to be viewed is not a stationary surface with a fixed structure but moving particles in a volume given by an illuminated section.

A calibration method for laser illuminated section techniques is further known from DE 198 01 615 A1, calibration of the evaluation unit being performed by quantitatively comparing an image captured by the camera in the target flow using one image scale with an image taken outside of the target flow using another image scale. The disadvantage of this method is that the cameras have to be moved very fast.

### BRIEF SUMMARY OF THE INVENTION

It is therefore the object of the invention to indicate a possibility of calibrating stereo-PIV methods that avoids the drawbacks described herein above i.e., calibration is intended to be performed at low expense, also in closed spaces and in microchannels as well.

This object is achieved, in accordance with the invention, in that the method for determining the imaging equation for self calibration with regard to performing stereo-PIV methods on visualized flows comprises at least two cameras and one illuminated section, with the cameras viewing approximately the same area of the illuminated section but from different directions, the point correspondences between the at least two cameras being determined by measuring the displacement of the respective interrogation areas in the camera images using optical cross-correlation, the imaging equation being determined by means of approximation methods, using known internal and external camera parameters. The important point in the method of the invention now is to determine the point correspondences described herein above between the at least two cameras. The point correspondences are determined—as already explained—using what is termed the optical cross-correlation. In optical cross-correlation, a camera image is captured by a camera at a certain instant of time t, the same camera image being taken by the second camera at the same instant of time t but in another direction. Meaning, the camera images both show the same image sector, but the images appear to be displaced, rotated or distorted relative to each other because of the optics of the viewing cameras. In order to determine the measured displacement of the camera images, every single camera image is divided in individual sections which are termed interrogation areas. This signifies that a camera image consists of e.g., 20×20 interrogation areas. Now, an interrogation area is determined in the first camera image and the corresponding correlating interrogation area in the second camera image as well. The spacing between the interrogation area of the first camera image and the interrogation area of the second image sector then yields the displacement of the camera images viewed by the camera optics. Finally, this spacing forms the highest correlation peak in the two-dimensional correlation function (dx, dy), with the position of this peak in the correlation field reproducing the position of the respective one of the cameras (x₁, y₁); (x₂, y₂). Accordingly, one obtains for each interrogation area a point correlation x₁, y₁⇄x₂, y₂.

Then, using one or several internal camera parameters, the point correspondences and an absolute length scaling, the remaining internal and external camera parameters can be determined, the entire imaging equation being determined using an approximation method, for example the Levenberg-Marquardt algorithm.

In a second, typical case, in which calibration has already been performed so that the internal and external parameters of the image are already known but not yet the position of the illuminated section in the space, the position of the one illuminated section or of the two illuminated sections of the two lasers in the space can be determined with the help of the point correspondences using current triangulation methods.

There is always a risk of the point correspondences having been erroneously determined. Meaning, the individual interrogation areas of the one camera image will not match those of the other camera image. These erroneous point correspondences may be eliminated by superimposing the known RANSAC algorithm on the actual approximation method.

As it is not a fixed surface that is viewed through the illuminated section but rather particles within a volume, particle arrays viewed by the one camera appear to be dramatically different when viewed by the other camera since the particles are arranged in space—depth of the illuminated section. As a result, the cross-correlation between the two camera images is very prone to errors since the right correlation peak is strongly blurred and is often lower than a random noise peak so that it is not recognized as such. This potential source of errors is advantageously eliminated by having the at least two cameras taking respectively at sequential times t₀ to tₙ two or more camera images, the two-dimensional correlation function c₀ (dx, dy) to cₙ (dx, dy) being determined by means of optical cross-correlation at each time t₀ to tₙ using these images, the correlation functions c₀ to cₙ being added up and the displacement dx, dy of the respective one of the interrogation areas and, as a result thereof, the point correspondences being determined after determination of the highest correlation peak.

The invention will be described in more detail herein after by way of example with reference to the drawings.

### BRIEF DESCRIPTION OF THE SEVERAL VIEWS OF THE DRAWING

FIG. 1 shows a typical stereo PIV assembly;

FIG. 2 schematically illustrates how correlation fields are obtained from cross correlating camera 1 and 2;

FIG. 3 shows the correlation fields obtained in FIG. 2 from the first (left side) laser and the second (right side) laser;

FIG. 4 shows the displacement vector computed from the position of the highest correlation peak magnified by a certain factor for enhanced visualization.

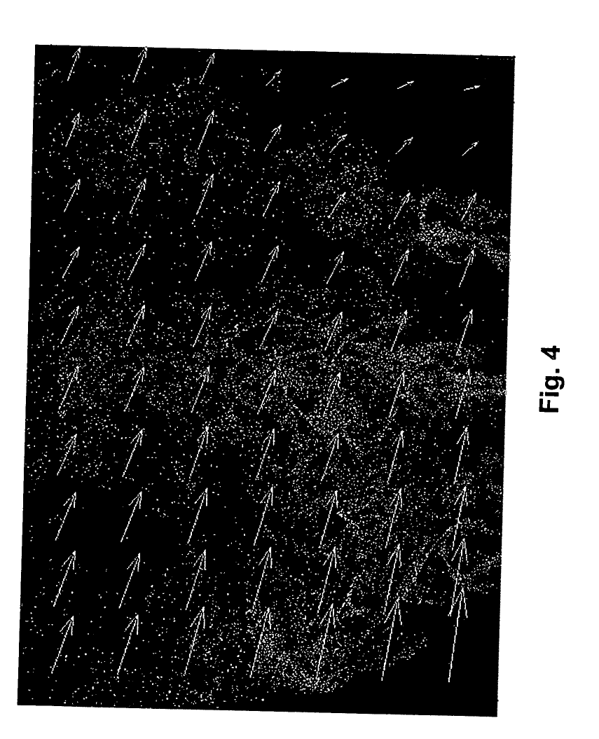

### DETAILED DESCRIPTION OF THE INVENTION

### EXAMPLE 1

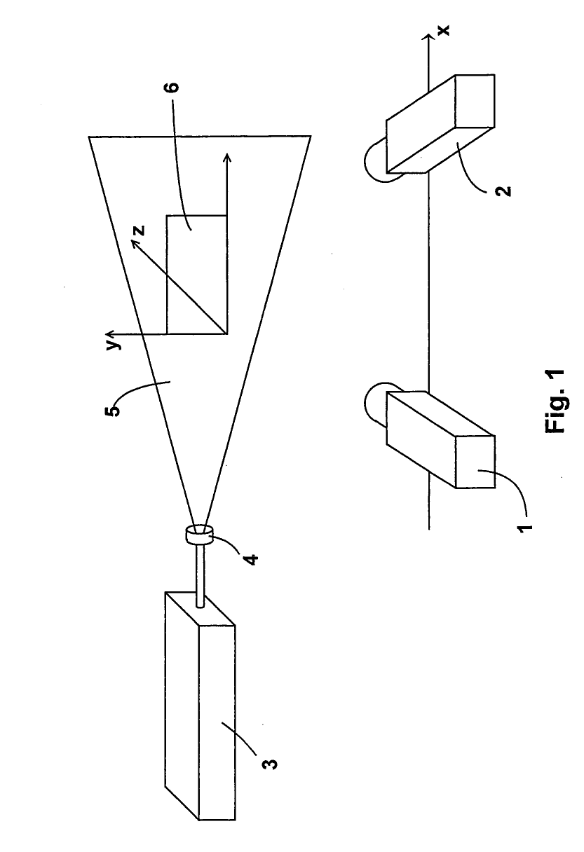

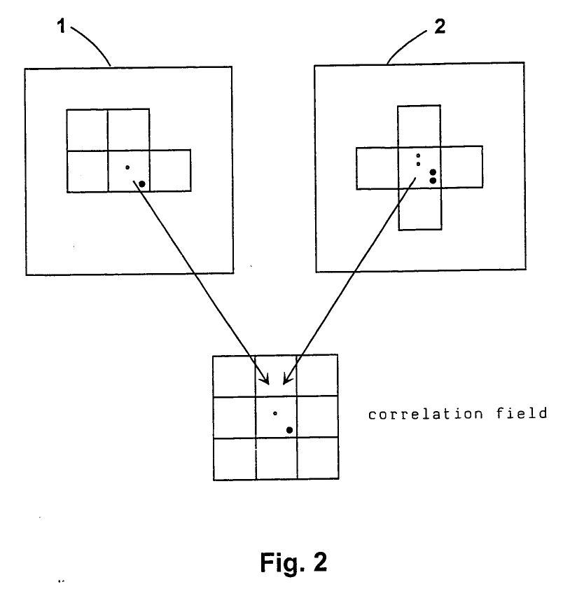

A current stereo-PIV assembly with two cameras (FIGS. 1 and 2) is taken as a basis, the cameras being positionable along the x-axis and being directed from either side toward the plane of the illuminated section at an angle typically ranging from 30.degree. to 50.degree., the plane of the illuminated section being defined by the x-y plane at z=0. As a result, the two cameras are located at z=−Zcam. The optical main axes of the cameras are coplanar and lie in a common x-y plane. Two pulsed lasers 3 produce the illuminated section 5 in short succession at the same position using an illuminated section optics 4, the two cameras taking two images 6 in short succession, with a laser pulse in each image.

In this example, volume calibration is assumed to have been performed independent of the actual illuminated section, two cameras having e.g., simultaneously image captured a 3D calibration plate. As a result, all of the internal and external imaging parameters relative to a system of coordinates based on the position of the calibration plate are known.

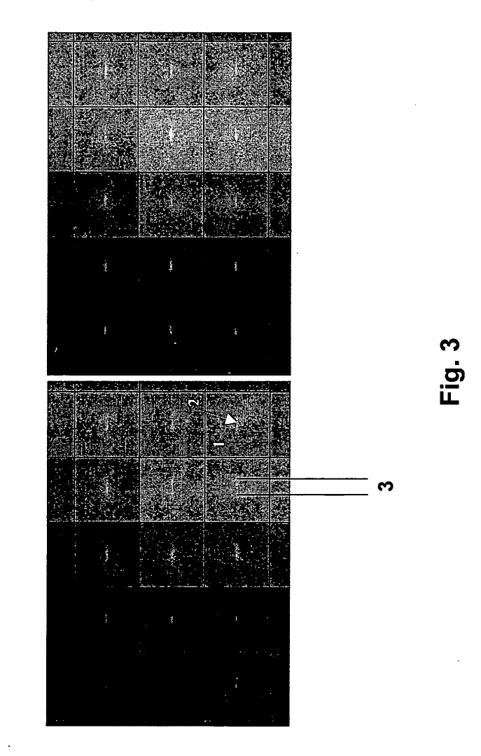

Using the optical cross-correlation between particle images taken simultaneously during the actual measurement, a summed correlation field is determined for each interrogation window (FIG. 3, no. 1) by taking the mean of the correlation fields recorded at different times, the position of the highest correlation peak (FIG. 3, no. 2—corresponds to an arrow in image 3) yielding the point correspondences between camera 1 and 2 (image 4). The base point of the arrows shows the position of an interrogation window in the image of camera 1 and the final point shows the corresponding point in the image of camera 2, with base point and final point forming together a point correspondence.

The absolute position of the illuminated section in space is then determined from the point correspondences by means of triangulation using the known imaging equation and the plane of the illuminated section is defined to be z=0 using a suited coordinate transformation. Thus the image for the plane of the illuminated section is determined and can be used for the actual stereo-PIV evaluation. The advantage of this method is that the calibration plate needs not be accurately positioned on the plane of the illuminated section but may be placed anywhere in the space while it is still possible to compute a highly accurate calibration on the plane of the illuminated section.

In addition, the thickness of the illuminated section is obtained directly from the width of the correlation peak (FIG. 3, no. 3) and a readily to be computed geometrical factor. On the left, FIG. 3 shows the correlation fields of laser 1 and on the right those of laser 2. The relative position of the two illuminated sections in space and their thickness are indicative of the overlap between the two illuminated sections and of whether they are suited for PIV measurement.

### EXAMPLE 2

The same experimental set-up is used as in Example 1. It is also assumed that the objective of the camera is angled relative to the camera plane in order to fulfill the Scheimflug condition so that all of the particles in the illuminated section are in focus. In this example, no previous calibration is provided, an imaging equation is intended to be determined from the very point correspondences. This is achieved using a direct approximation method in which the missing image parameters are fitted. Since there are too many free parameters, certain assumptions must be made in order to converge on a solution. There are various possibilities to reduce the number of free parameters with the help of known conditions:

It is assumed that it is known from a previous calibration of the Scheimflug adapter, which has only to be carried out once, how the principal point is displaced as a function of the angle, or the Scheimflug condition is calculated directly from the geometry. Accordingly, the principal point needs not be fitted as well but is a function of the external viewing angles that are fitted.

The same approach is taken for the image width. The image width is calculated from the lens equation 1/B+1/G=1/f, with B=image width, G=object value and f=known focal length of the camera objective. During approximation, the focal length is thus calculated as a function of the width of the object, G having to be fitted as a free external parameter. As an alternative to the lens equation, it is also possible to previously empirically calibrate the dependence of the image width on the width of the object for each camera separately.

An additional possibility is to further reduce the number of free parameters by taking advantage of the fact that the optical main axes are coplanar in this case.

The advantage of this method is that an in situ calibration can be completely dispensed with, the imaging equation being entirely computable from the calculated point correspondences with assumption of some known conditions. Measurement is thus considerably facilitated for a user of the PIV technique.

I claim:

1. A method for determining the imaging equation for self calibration with regard to performing stereo-PIV methods on visualized flows, said method being comprised of at least two cameras and one image sector, with the cameras viewing approximately the same area of the illuminated section but from different directions, the point correspondences between the two cameras being determined by measuring the displacement of the respective interrogation areas in the camera images using optical cross-correlation, the imaging equation being determined by means of approximation methods, using known internal and external camera parameters.

2. The method according to claim 1, characterized in that the internal camera parameters include the focal length, the position of the optical axes (x₀, y₀) and distortion parameters of the camera optics.

3. The method according to claim 1, characterized in that the external parameters include the position and orientation of the cameras relative to each other.

4. The method according to one or several of the above mentioned claims, characterized in that, if the position of the illuminated section relative to the coordinate system of a known imaging equation is unknown, the position of the illuminated section is determined using the point correspondences.

5. The method according to one or several of the above mentioned claims, characterized in that, if one or several internal camera parameters are known, the other internal and external camera parameters are determinable using the point correspondences in order to thus determine the imaging equation.

6. The method according to one or several of the above mentioned claims, characterized in that two or more camera images are taken by the at least two cameras at sequential times t₀ to tₙ, the two-dimensional correlation function c₀ (dx, dy) to cₙ (dx, dy) being determined by means of optical cross-correlation at each time t₀ to tₙ using these images, the correlation functions c₀ to cₙ being added up and the displacement dx, dy of the respective one of the interrogation areas and, as a result thereof, the point correspondences being determined after determination of the highest correlation peak.

7. The method according to one or several of the above mentioned claims, characterized in that the approximation method is based on the Levenberg-Marquardt algorithm.

8. The method according to claim 7, characterized in that the RANSAC algorithm is superimposed on the Levenberg-Marquardt algorithm.

9. The method according to claim 1, characterized in that each camera takes in short succession two images and that additional point correspondences are determined using a cross-correlation between the images at the times t and t+dt.

10. The method according to claim 1, characterized in that the optical axes of at least two cameras are disposed coplanar to each other.

11. The method according to claim 6, characterized in that the section thickness of the two illuminated sections is determined through the width of the correlation peaks and a geometrical factor and that, together with the position of the illuminated sections in the space, said thickness serves to determine the overlap between the two illuminated sections and whether they are suited for PIV measurement.

12. The method according to claim 5, characterized in that, with assumption of focussing on the particles in the illuminated section during the approximation method, the image width is calculated as a function of the focal length of the objective and of the spacing between the illuminated section and the camera and needs no longer be fitted as a result thereof.

13. The method according to claim 5, characterized in that, if a Scheimflug adapter is used and with assumption that said Scheimflug adapter is optimally adjusted, the angle between camera chip and main axis and the position of the principal point on the camera chip are computed from the external image parameters and need no longer be fitted as a result thereof.

14. The method according to claim 6, characterized in that, the section thickness of the two illuminated sections is determined through the width of the correlation peaks and the image geometry and that, together with the position of the illuminated sections in the space, said thickness serves to determine the overlap between the two illuminated sections and whether they are suited for PIV measurement.
